(19) United States
(12) Patent Application Publication
(10) Pub. No.: US 2010/0110402 A1
(43) Pub. Date: May 6, 2010

(54) FOCUS CORRECTION IN LITHOGRAPHY TOOLS VIA LENS ABERRATION CONTROL

(76) Inventors: Rene WIRTZ, Stuttgart (DE); Rolf SELTMANN, Dresden (DE)

Correspondence Address: WILLIAMS, MORGAN & AMERSON, 10333 RICHMOND, SUITE 1100, HOUSTON, TX, 77042, US

(21) Appl. No.: 12/579,507

(22) Filed: Oct. 15, 2009

(30) Foreign Application Priority Data
Oct. 31, 2008 (DE) 10 2008 053 954.6

(51) Int. Cl. G03B 27/52; G03B 27/32

(52) U.S. Cl. 355/55; 355/77

(57) ABSTRACT

Aberration control capabilities of sophisticated lithography tools may be exploited in order to locally adapt the focal surface of the optical system. That is, higher order correction terms may be incorporated in the design of the local surface in addition to the conventionally used first order corrections, thereby enhancing uniformity of the lithography process and thus of corresponding microstructure devices.

### BACKGROUND OF THE INVENTION

1. Field of the Invention

Generally, the present disclosure relates to the field of fabricating microstructures, such as integrated circuits, and, more particularly, to adjusting focus during exposure processes.

2. Description of the Related Art

The fabrication of microstructures, such as integrated circuits, requires tiny regions of precisely controlled size to be formed in a material layer of an appropriate substrate, such as a silicon substrate, a silicon-on-insulator (SOI) substrate or other suitable carrier materials. These tiny regions of precisely controlled size are generated by patterning the material layer by performing lithography, etch, implantation, deposition and oxidation processes and the like, wherein, typically, at least in a certain stage of the patterning process, a mask layer may be formed over the material layer to be treated to define these tiny regions. Generally, a mask layer may consist of or may be formed by means of a layer of radiation-sensitive material, such as photoresist, that is patterned by a lithographic process, typically a photolithography process. During the photolithography process, the radiation-sensitive material or resist may be applied to the substrate surface and then selectively exposed to ultraviolet radiation through a corresponding lithography mask, such as a reticle, thereby imaging the reticle pattern into resist layer to form a latent image therein. After “developing” the photoresist or any other radiation-sensitive material, depending on the type of resist or radiation-sensitive material, positive resist or negative resist, the exposed portions or the non-exposed portions are removed to form the required pattern in the layer of photoresist or radiation-sensitive material. Based on this resist pattern, actual device patterns may be formed by further manufacturing processes, such as etch, implantation and anneal processes and the like.

Since the dimensions of the patterns in sophisticated integrated microstructure devices are steadily decreasing, the equipment used for patterning device features have to meet very stringent requirements with regard to resolution and overlay accuracy of the involved fabrication processes. In this respect, resolution is considered as a measure for specifying the consistent ability to print minimum size images under conditions of predefined manufacturing variations. One important factor in improving the resolution is represented by the lithographic process, in which patterns contained in the photo mask or reticle are optically transferred to the substrate via an optical imaging system. Therefore, great efforts are made to steadily improve optical properties of the lithographic system, such as numerical aperture, depth of focus and wavelength of the light source used.

As is well known, the resolution of an optical system is proportional to the wavelength of the light source used and to a process-related factor and is inversely proportional to the numerical aperture. For this reason, the wavelength may be reduced and/or the process-related factor may be reduced and/or the numerical aperture may be increased in an attempt to increase the overall resolution. In recent years, all three approaches have been concurrently taken resulting in highly complex lithography systems in which the finally achieved resolution may be well below the wavelength of the radiation used for exposure. On the other hand, depth of focus, i.e., the range within objects may be imaged with sufficient accuracy, is inversely proportional to the square of the numerical aperture so that recent developments in increasing the numerical aperture may finally result in a significantly reduced depth of focus, which may therefore have a significant influence as corresponding objects, such as resist layers and the like, may still have a pronounced dimension in the height direction. For example, in advanced semiconductor devices or any other microstructure devices, corresponding topography variations may thus result in a significant modification of the final critical dimension, which in turn may lead to corresponding non-uniformities with respect to performance of, for instance, complex integrated circuits.

In addition to topography-related process non-uniformities, the imaging system itself may suffer from imperfections, thereby also contributing to corresponding process and device non-uniformities. Typically, in advanced lithography tools, optical projection systems are provided which may reduce a mask feature formed in the reticle by a certain factor, for instance 5:1, 2:1 and the like, thereby providing significant advantages with respect to the fabrication of the masks since the corresponding mask features may be formed on the basis of less critical dimensions. These projection systems typically comprise a plurality of lenses formed of two or more materials that may provide the desired characteristics for the wavelength under consideration. Due to any imperfections during the manufacturing process, for instance with respect to appropriately shaping the individual lenses and due to imperfections in the materials used, a certain degree of deviation of an ideal imaging behavior may typically be encountered, which may also be referred to as lens aberration. This non-ideal imaging behavior or lens aberration may usually be quantitatively estimated after manufacturing a corresponding optical system and also during operation thereof, which may be accomplished by determining a so-called wave front aberration, which quantitatively describes the discrepancy of an ideal wave front from the actual wave front produced by the lithography system. However, corresponding wave front or lens aberrations may also be caused by environmental influences, such as temperature, humidity, pressure and the like, which may require sophisticated compartments for accommodating the complex optical systems, the light source, the substrate to be exposed and the like. Nevertheless a certain degree of variability of the lens aberrations may be observed, in particular when complexity of the corresponding lithography tool increases.

As a consequence, in many available sophisticated lithography tools, corresponding lens aberrations may be compensated for, at least to a certain degree, by implementing corresponding aberration control units in which one or more parameters of the optical imaging system may be varied to maintain the imaging behavior within a well-specified range. For example, a local temperature control of various components of the imaging system may be provided so as to allow a local adaptation of optical paths, which in turn may enable an efficient correction of lens aberration. That is to say, by appropriately operating the corresponding lens aberration control unit, a non-desired “deformation” of the wave front, which may be caused by environmental conditions, subtle variations of the overall setup of the lithography tool and the like, may be compensated for by locally varying the optical paths within one or more components of the imaging system, for instance by locally adjusting the temperature, moving lens components, varying index of refraction in a local manner and the like.

During a lithography process, a basic setting of the wave front may be initiated on the basis of a corresponding set of measurement data indicating the current status of the lithography tool. Moreover, upon processing the substrates under consideration, complex procedures for aligning the substrates with respect to the lithography mask may be performed in an automated manner and also corresponding focus finding procedures may typically be carried out. In sophisticated lithography techniques, a step and scan strategy is frequently used in which generally the position of an exposure field may be defined on the substrate to be exposed, requiring a precise alignment of the exposure field, and thereafter a scan process may be performed in which the exposure field, i.e., the substrate, and the lithography mask are simultaneously moved across a corresponding exposure slit. In order to obtain a desired high accuracy and uniformity across the entire exposure field, a precise setting of the focal plane has to be accomplished so that, desirably, each position of the exposure field within the exposure slit is maintained within the allowed focus range. That is, depending on the lithography mask and the lithography process under consideration, an appropriate height position of the resist layer to be exposed has to be determined during the automatic focus adjustment procedure in order to avoid undue distortion of critical features. For this purpose, frequently, a focus-exposure matrix may be determined for the process under consideration in order to obtain appropriate parameter values for positioning a corresponding exposure field at an appropriate height level so as to stay within the allowable focus range. For this purpose, additional optical components, such as lasers and the like, or the inherent optical system may be used to adjust the distance of the substrate, i.e., the exposure field, with respect to the optical system. For this purpose, the substrate may be moved in the height direction and may also be tilted with respect to specified directions, i.e., with respect to orthogonal angular directions, in order to automatically estimate on the basis of optical data gathered for different values of the associated tilt angles, an optimum focused state of the exposure field under consideration.

During this focusing procedure, the corresponding tilt angles in the two orthogonal angular directions may be varied in relation to a reference position until a corresponding appropriate automated focusing algorithm indicates an appropriate position that is considered the “best” focus position. In other cases, as previously discussed, a corresponding adjustment of the position of the exposure field, i.e., the position of the focal plane with respect to the substrate surface, may be obtained on the basis of previously obtained measurement data, as indicated by a corresponding focus-exposure matrix, which includes corresponding measurement data, for instance on the basis of critical dimensions obtained for various positions for each of the corresponding exposure fields. Thus, the adjustment of the general height position may allow a correction of an offset of the focal plane with respect to the substrate surface, while the two orthogonal tilt angles may provide a correction of first order terms of the focal plane, i.e., the focal plane as a whole may be inclined within the exposure slit. However, as previously explained, in sophisticated applications, typically, a pronounced surface topography may be produced during various manufacturing stages, which may not be efficiently compensated for by first order focus corrections.

For instance, in the overall manufacturing flow for forming complex integrated circuits, a plurality of process steps may result in a locally different removal rate for various materials, which may be caused by a difference in pattern density in the various device regions. Pattern density is to be understood as the number of certain device features per unit area, which may thus contribute to a different removal behavior during processes such as etching, chemical mechanical polishing (CMP) and the like. For instance, a significant difference in topography may be encountered between a die region and the corresponding frame enclosing the die region, which may result in a difference of removal rate, for instance during CMP, which is a frequently used process technique to remove excess material and planarize a current device level prior to performing a further critical lithography step. Thus, after repeatedly performing a corresponding CMP process, increasingly, a difference in the overall surface topography may be caused between the die region and the frame, which may thus finally result in a difference of the imaging process due to the different local height levels that may not be efficiently compensated for on the basis of the above-described focus adjustment techniques.

The present disclosure is directed to various methods and systems that may avoid, or at least reduce, the effects of one or more of the problems identified above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

Generally, the present disclosure relates to methods and systems in which the focus condition may be locally enhanced within an exposure field and thus within a corresponding exposure slit, if scan and step photolithography tools may be used, by taking into consideration higher order focus corrections. For this purpose, in some illustrative aspects disclosed herein, the wave front may be appropriately adapted to the surface topography of the substrate under consideration in order to locally maintain the various portions of the exposure field in a specified allowable range of focus values. To this end, well-established lens aberration control systems may be used, which may allow a high degree of freedom in appropriately adjusting the wave front and which are conventionally used for compensating for tool-specific wave front aberrations. Thus, by creating a non-planar focal surface, an enhanced degree of adaptation of the focal surface to the surface topography under consideration may be accomplished, which may not be achieved by conventional focus adjusting procedures including zero and first order corrections. Hence, by higher order focus corrections on the basis of lens aberration control techniques, overall quality of lithography processes may be enhanced, thereby also reducing non-uniformities in sophisticated microstructure devices, since, for instance, a significant difference in topography between die regions and frames may be compensated for, at least to a certain degree, thereby also reducing discrepancies between critical features in the die center and the die edge.

One illustrative method disclosed herein comprises obtaining measurement data indicating a depth of focus across a portion of an exposure field of a substrate exposed by an exposure tool. The method further comprises adjusting one or more exposure tool parameters to create a non-planar focal surface on the basis of the measurement data.

A further illustrative method disclosed herein relates to adjusting a focus of an exposure tool. The method comprises determining at least one higher order term for a focal surface of the exposure tool and adjusting a lens aberration of a lens system of the exposure tool by using the at least one higher order term to obtain a non-planar focal surface. The method further comprises exposing a portion of a substrate by using the non-planar focal surface.

One illustrative exposure system disclosed herein comprises an imaging unit comprising a radiation source and an optical system. Moreover, an operation control unit is operatively connected to the optical system and is configured to adjust aberration of the optical system. Furthermore, the exposure system comprises a focal surface adjustment unit operatively connected to the aberration control unit and configured to provide one or more target parameter values to the aberration control unit, wherein the one or more target parameter values are determined so as to correct at least one higher order term of a focal surface.

### BRIEF DESCRIPTION OF THE DRAWINGS

The disclosure may be understood by reference to the following description taken in conjunction with the accompanying drawings, in which like reference numerals identify like elements, and in which:

FIGS. 1a-1b schematically illustrate a top view and a cross-sectional view, respectively, of a portion of a substrate to be exposed, such as a die region embedded in a frame in a sophisticated semiconductor device;

FIG. 1c schematically illustrates a focus adjustment unit receiving focus-related measurement data and outputting target parameters for an aberration control unit, according to illustrative embodiments;

FIG. 1d schematically illustrates focus-related measurement data obtained at various positions and including zero order, first order and higher order corrections of a focal surface, according to illustrative embodiments;

FIG. 1e schematically illustrates a schematic view of an exposure tool including a focus adjustment unit, according to illustrative embodiments;

FIG. 1f schematically illustrates a substrate during a focus adjustment procedure performed on the basis of first order corrections; and

FIG. 1g schematically illustrates a focal correction strategy based on topography data and focus alignment data, according to still further illustrative embodiments.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

Generally, the present invention relates to methods and exposure systems in which enhanced focus conditions may be accomplished during exposure of microstructure devices in that tool-internal aberration control capabilities may be used for adapting the focal “plane” of the exposure tool to the surface topography of the exposure field under consideration. That is, as previously discussed, during the processing of microstructure devices, respective topography discrepancies between various positions across the substrate portion under consideration may occur, temporarily or permanently, which may typically result in corresponding exposure non-uniformities and thus dimensional non-uniformities of the corresponding device features, since conventional first order focus corrections may provide an average correction while, however, ignoring local variations of the topography. According to the principles disclosed herein, focus-related measurement data may be used to appropriately “design” the focal surface for the exposure process under consideration in order to maintain an increased portion of the exposure field within an appropriate focus range. For example, a corresponding curvature of the focal surface may be produced across the exposure slit of a scan and step lithography tool, thereby providing a significantly higher degree of freedom in accomplishing enhanced focus conditions compared to conventional first order corrections in which a corresponding substrate surface may be tilted as a whole, thereby also obtaining a relative “tilt” of the focal plane as a whole and hence requiring a compromise with respect to the “best” focus for various positions across the exposure slit.

It should be appreciated that the present disclosure is highly advantageous in the context of sophisticated step and scan lithography tools, since enhanced adaptation of the focal conditions across the exposure slit may be accomplished, thereby enabling the reduction of exposure non-uniformities for critical microstructure devices. However, the technical teaching disclosed herein may also be applied to any type of lithography tool that provides the capability of adjusting the wave front by means of a tool-internal control system. Thus, unless specifically set forth in the appended claims and/or any embodiments of the specification, the present disclosure should not be considered as being restricted to any specific type of exposure tool or any type of substrate to be processed therein.

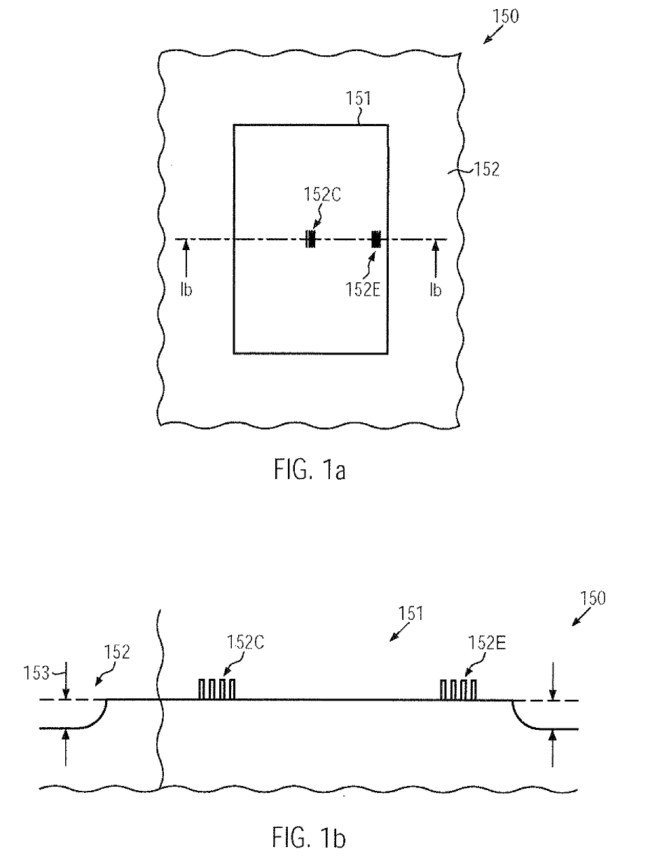

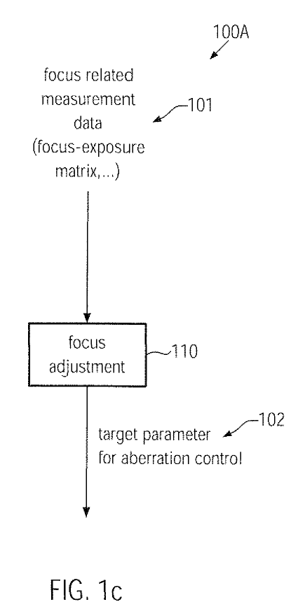

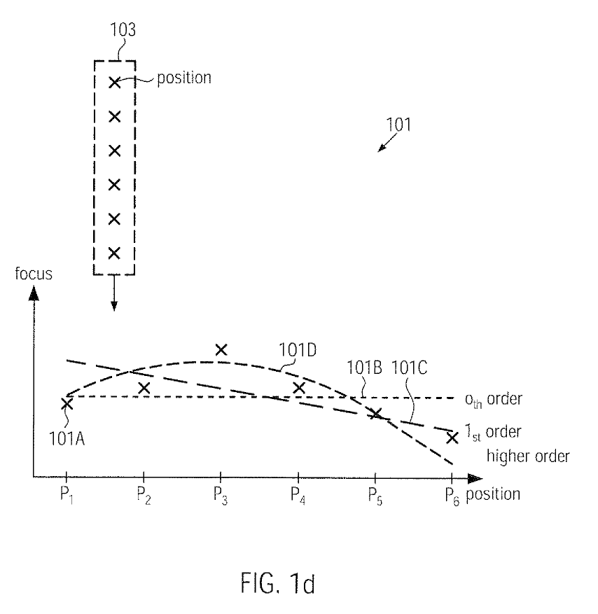

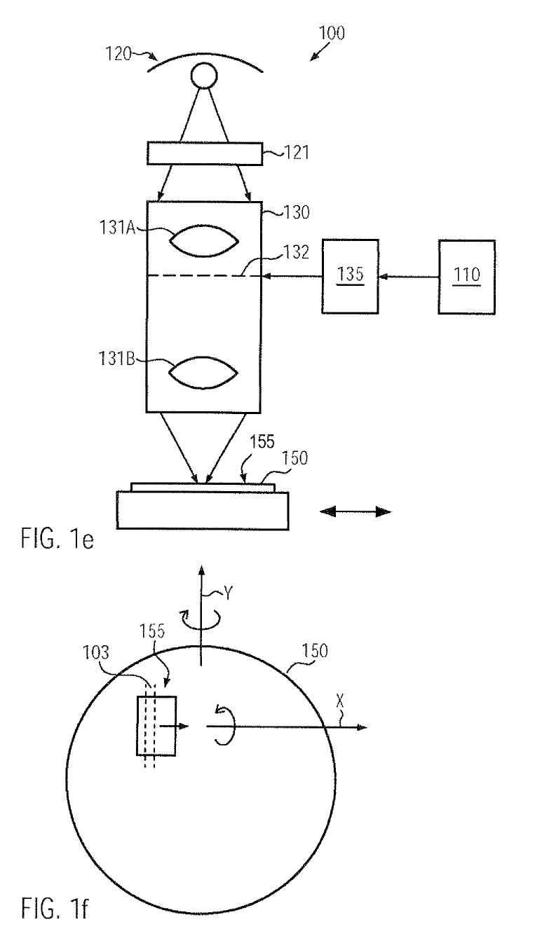

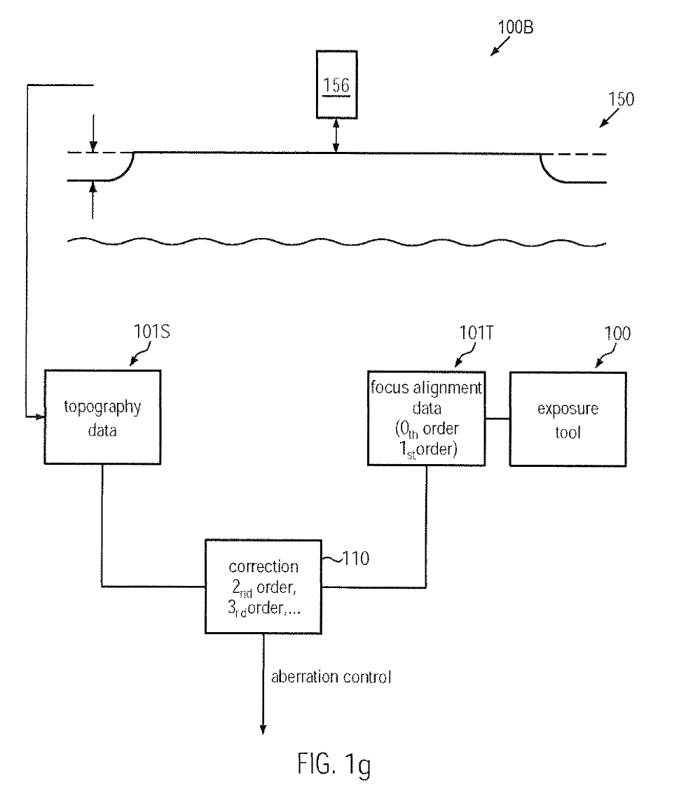

FIG. 1a schematically illustrates a top view of a portion of a substrate 150 which, in some illustrative embodiments, may represent a portion of a substrate for forming therein and thereon microstructure devices, such as integrated circuits and the like. For example, the substrate 150 may represent a semiconductor substrate for forming thereon integrated circuits, which may typically be provided in the form of die 151, which may be laterally enclosed by a frame region 152 which represent corresponding scribe lanes for separating the substrate 150 into individual chips in a very advanced manufacturing stage. Thus, within the region or die 151, a plurality of device features, such as circuit elements and the like, are typically to be formed by using microelectronic or micromechanical manufacturing techniques wherein lithography processes may represent one important and critical category of manufacturing processes. Thus, a plurality of critical device features 152C and 152E may be provided, depending on the stage of the overall manufacturing process. For example, the features 152C, 152E may represent critical features, such as gate electrodes of field effect transistors, metal lines, vias and the like. As previously explained, during the complex manufacturing flow for forming the device features 152A, 152E, a local variation in topography may be generated, for instance with respect to the frame 152 and the die 151.

FIG. 1b schematically illustrates a cross-sectional view of the substrate 150 along the section Ib of FIG. 1a. As illustrated, a difference in height level, indicated as 153, may be present between the frame 152 and the actual die 151. In the example shown, more material may have been removed from the substrate 150 in the frame 152 compared to the die 151, which may thus result in corresponding non-uniformities during corresponding lithography processes for forming the device features 152C, 152E. For example, in conventional strategies, the actual critical dimensions for the features 152C may differ from that of the features 152E, which may be caused by a significantly different position of the features 152E with respect to a corresponding focal plane compared to the features 152C, as previously explained. Consequently, according to some illustrative embodiments disclosed herein, the surface topography 153 of the substrate 150 may be taken into consideration by evaluating focus-related measurement data which may then be used for designing an appropriate focal surface for an exposure process to be performed on the substrate 150.

FIG. 1c schematically illustrates a corresponding process strategy 100A, in which focus-related measurement data 101 may be supplied to a focus adjustment unit 110 to obtain an appropriately designed focal surface. For this purpose, the focus-related measurement data 101 may be provided in any appropriate form, for instance as a focus-exposure matrix, in which various focus values in combination with a plurality of exposure dose values may be used for exposing device features, for instance based on a specifically designed lithography mask, so that the result of the corresponding exposure processes may be evaluated on the basis of measurement data, for instance a line width, a height of the features, a sidewall angle thereof and the like. Thus, the focus-related measurement data, for instance based on the focus-exposure matrix, may have “encoded” therein the surface topography of the substrate 150 when a corresponding processed substrate may be used for producing the corresponding test structure. In other cases, as will be described later on in more detail, topography-related measurement data and focus-related measurement data may be separately gathered and may be supplied to the focus adjustment unit 110, which may then determine on the basis of the measurement data 101 and any other focus- and topography-related measurement data one or more target parameter values for an aberration control unit of an exposure system. That is, the focus adjustment unit 110 may provide a corresponding aberration setting information 102, for instance in the form of a control signal, digital data and the like, to enable a lithography tool to initiate corresponding actions for varying the optical path in a highly local manner, so that a desired “deformation” of the wave front may be obtained in relation to the measurement data 101.

FIG. 1d schematically illustrates an example of the measurement data 101, which may already represent specifically processed versions of the measurement data 101, depending on the overall process strategy. As illustrated, respective points 101A of “best focus” may have been determined for various positions P₁ . . . P₆. For instance, corresponding measurement data of critical dimensions and the like may be evaluated for the various positions P₁ . . . P₆ to identify one of several focus values used during the corresponding exposure processes. For instance, the corresponding focus value resulting in a best match of a desired critical dimension may be selected as the point 101A for the corresponding position P₁ . . . P₆. For instance, the positions P₁ . . . P₆ may represent an exposure slit 103 of an exposure tool. As previously explained, the data 101A may be used for defining an appropriate focal surface so that a desired process result may be obtained for each of the positions P₁ . . . P₆. For this purpose, in conventional strategies, corresponding focus finding or focus adjustment procedures may be used in which a basic constant focus offset, as indicated by 101B, may be determined and may be considered as an adjustment or correction of zero-th order, since the height level of the substrate 150 (FIGS. 1a-1b) as a whole may be selected so as to fit the various points 101A. Furthermore, a first order correction, as indicated by 101C, may be used by tilting the substrate 150 so that a corresponding focal plane may be obtained that allows more positions P₁ . . . P₆ to be within an acceptable range of focus values. However, in the case of a pronounced surface topography, as previously explained, the focal plane 101C corresponding to a first order correction may still result in a significant non-uniformity due to a moderately high deviation of the focal plane 101C from the corresponding points of best focus 101A. Consequently, by using second order and even higher order terms in appropriately fitting the points 101A, a non-planar focus surface, indicated as 101D, may be defined which may thus provide enhanced focus conditions at at least a plurality of the positions P₁ . . . P₅. For instance, the focal surface 101D may be represented by a polynomial of a desired order, for instance as indicated by Equation 1:

focus=A₀+A₁P+A₂P²+A₃P³+ (Equation 1)

In Equation 1, the variable P may represent the position, while the coefficients A thus represent appropriately selected factors of the various higher order terms, which may be obtained by established automatic fit procedures and the like. By taking into consideration the coefficients A₂ . . . , a corresponding curvature may be obtained, thereby allowing enhanced adaptation of the focal surface 101D to the actual exposure conditions represented by the measurement data 101A. Thus, based on the required higher order terms for appropriately determining the non-planar focal surface 101D, the focus adjustment unit (FIG. 1c) may provide appropriate target parameter values for corresponding tool-specific parameters, which may enable a local adaptation of the optical path of a corresponding imaging system.

It should be appreciated that a correlation between the corresponding parameters used for operating an aberration control unit and the desired shape of the focal surface 101D may be readily established on the basis of test measurements. For example, respective parameter settings for the aberration control may be determined for one or more reference focal surfaces so that a variation in the shape of the desired focal surface with respect to the one or more reference surfaces may be related to the variation of the one or more process parameters and may be obtained by, for instance, interpolation and the like. It should be appreciated, however, that any other strategy may be used for converting the determined higher order focal surface 101D into appropriate parameter values for a corresponding aberration control unit, depending on the capabilities of the tool-internal system.

FIG. 1e schematically illustrates an exposure tool 100 comprising an illuminating system 120 that is configured to provide an appropriate exposure radiation and to pass the radiation through a lithography mask 121. Furthermore, the exposure tool 100 may comprise an optical system 130, which may include a plurality of optical components 131A, 131B and the like which may represent transmissive and/or reflective components, such as lenses, mirrors and the like. Moreover, the optical system 130 may comprise appropriate hardware components 132 that may enable an adaptation of the wave front generated by the optical system 130. That is, the optical system 130 may be configured to provide an exposure slit on the substrate 150, as previously explained, and in this case the hardware components 132 may enable a correction or adaptation of the wave front across the exposure slit to compensate for tool-internal aberrations of the optical system 130, as may typically be required due to, for instance, environmental influences and the like. For this purpose, the hardware components 132 which may also be considered as aberration adjustment components may be connected to a corresponding aberration control unit 135, which may provide appropriate control signals to the components 132 in order to obtain a desired adaptation of the wave front. As discussed above, a corresponding wave front adaptation or aberration control system comprising the components 132 and 135 may be provided in sophisticated lithography tools. Additionally, the exposure system 100 may comprise the focus adjustment unit 110 that is connected to the unit 135 to supply corresponding target values that may cause the unit 135 to generate appropriate control signals for the components 132, which may finally result in a corresponding adaptation of the wave front produced by the system 130. Hence, the resulting focal surface of the optical system 130 may be “modulated” in relation to the desired focal surface, such as the surface 101D as illustrated in FIG. 1d. For example, the respective target parameter values may represent values for controlling the temperature of one or more of the optical components 131A, 131B via the components 132 in a highly local manner, or corresponding spatial relations between the components 131A, 131B may be adjusted via the components on the basis of the corresponding target parameter values supplied by the unit 110.

Hence, during operation of the exposure system 100, a portion of the substrate 150, that is, a corresponding exposure field, may be exposed on the basis of desired focal surface determined by the unit 110. Hence, the corresponding exposure field 155 may be maintained within enhanced focus conditions compared to conventional strategies in which only first order focus corrections may be performed, as previously discussed.

FIG. 1f schematically illustrates the substrate 150 during a corresponding focus finding procedure in which an exposure field 155, which is to be understood as a portion of the substrate 150 that may be exposed during one continuous exposure process based on a single set of exposure parameters with respect to alignment and focus values. For example, in a step and scan system, the exposure field 155 may be scanned by the slit 103 for a given set of alignment parameters and focus values. Thus, prior to the actual exposure process, the substrate 150 may be positioned and aligned, that is, the exposure field 155 may be positioned with respect to the lithography mask 121 (FIG. 1e) which may be accomplished by translations in orthogonal directions and also by rotating the substrate 150 with respect to a rotation axis that is perpendicular to the substrate surface. On the other hand, zero order and first order corrections of the focal surface may be accomplished on the basis of conventional strategies in which corresponding tilts may be performed around on the axes X and Y, as indicated in FIG. 1f, while also a positioning in the height direction, i.e., in a direction perpendicular to the surface of the substrate 150, may be carried out. Consequently, the zero and first order corrections may be performed by “mechanical” adjustment of the substrate 150, while the higher order corrections may be accomplished by appropriately adjusting the operation of the optical system 130 on the basis of the unit 110 (FIG. 1e).

FIG. 1g schematically illustrates a further focus adjustment strategy 100B according to further illustrative embodiments in which topography-related measurement data 101S may be obtained from a substrate to be processed, such as the substrate 150, while additionally focus alignment data 101T may be obtained from the exposure tool 100, wherein the corresponding data 101T may be obtained during one or more focus adjustment procedures as described with reference to FIG. 1f. That is, the focus alignment data 101T may be obtained and may thus represent zero order and first order correction data, which may be available from the exposure tool 100 after adjusting the focus of one or more previously processed substrates. The data 101S and 101T may be supplied to the focus adjustment unit 110, which may determine an appropriate focal surface adapted to the topography of the substrate 150 and including higher order terms. For example, the topography-related measurement data 101S may be obtained by inline measurement techniques, such as optical inspection techniques and the like, generally indicated as 156, so that a corresponding delay between obtaining relevant topography data and the processing of further substrates having an equivalent topography may be moderately short. Similarly, the focus alignment data 101T may be obtained without significant delay. Consequently, appropriate parameter values for controlling the lens aberration of the system 130 (FIG. 1e) may be obtained without significant delay, thereby providing enhanced controllability.

Upon receiving the topography data 101S and the focus alignment data 101T, both data may be appropriately “superimposed” or combined in order to obtain the desired final non-planar focal surface that reflects the topography of the substrate 150. For this purpose, the focus alignment data 101T may be considered as coarse data representing the general height and inclination of a focal plane, wherein the “fine tuning” of the focal plane, i.e., the generation of a specific focal surface adapted to the topography, may be accomplished by locally creating a curvature based on the first order correction represented by the alignment data 101T.

As a result, the present disclosure provides methods and exposure systems in which a focal surface may be designed in a locally resolved manner by including higher order corrections, thereby providing the possibility of adapting the focal surface locally to the topography of the surface to be exposed. The higher order correction or adaptation of the “focal plane” may be accomplished by using tool-internal aberration control capabilities in order to locally adjust the wave front created by the optical system of the lithography tool. Hence, in critical lithography processes, increased portions of the exposure field may be maintained within an enhanced focus range, which may translate into less non-uniformities of the lithography process and thus of the finally produced device features.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
obtaining measurement data indicating a depth of focus across a portion of an exposure field of substrate exposed by an exposure tool; and
adjusting one or more exposure tool parameters to create a non-planar focal surface on the basis of said measurement data.

2. The method of claim 1, wherein said one or more exposure tool parameters comprises one or more parameters for controlling lens aberration of an optical system of said exposure tool.

3. The method of claim 1, wherein said measurement data indicate a depth of focus across an exposure slit of said exposure tool.

4. The method of claim 1, wherein adjusting one or more exposure tool parameters comprises determining a first order correction on the basis of said measurement data and using said first order correction to determine a tilt angle of a substrate.

5. The method of claim 4, wherein adjusting said one or more exposure tool parameters further comprises determining at least one higher order correction on the basis of said measurement data and using said at least one higher order correction to determine a lens aberration parameter.

6. The method of claim 5, wherein determining at least one higher order correction comprises determining a higher order polynomial to fit said measurement data.

7. The method of claim 1, wherein said measurement data are obtained on the basis of a focus exposure matrix.

8. The method of claim 1, wherein said measurement data are obtained by using process data of said exposure tool obtained during automatic focus finding procedures performed on one or more previously processed substrates.

9. The method of claim 1, wherein said measurement data include information with respect to an edge region of a die positioned in said exposure field.

10. A method of adjusting a focus of an exposure tool, the method comprising:
determining at least one higher order term for a focal surface of said exposure tool;
adjusting a lens aberration of a lens system of said exposure tool by using said at least one higher order term to obtain a non-planar focal surface; and
exposing a portion of a substrate by using said non-planar focal surface.

11. The method of claim 10, wherein said at least one higher order term is determined by adapting a higher order polynomial to measurement data indicating a depth of focus of said exposure tool.

12. The method of claim 11, wherein said measurement data are obtained by producing a focus-exposure matrix.

13. The method of claim 11, wherein said measurement data are obtained by using process data obtained during one or more automatic focus adjustment procedures performed on one or more substrates previously processed in said exposure tool.

14. The method of claim 10, further comprising determining a first order term of said focal surface and correcting said first order term by adjusting a tilt angle.

15. The method of claim 10, wherein said focal surface is determined so as to extend at least across a die edge region within an exposure field produced by said exposure tool when exposing said portion of said substrate.

16. The method of claim 10, wherein determining at least one higher order term of a focal surface comprises determining a topography of said portion of said substrate.

17. The method of claim 16, wherein determining said topography comprises determining a difference in height level of a center of a die region and an edge of said die region.

18. An exposure system, comprising:
an imaging unit comprising a radiation source and an optical system;
an aberration control unit operatively connected to said optical system and configured to adjust aberration of said optical system; and
a focal surface adjustment unit operatively connected to said aberration control unit and configured to provide one or more target parameter values to said aberration control unit, said one or more target parameter values being determined to correct at least one higher order term of a focal surface.

19. The exposure system of claim 18, wherein said focal surface adjustment unit is further configured to determine said one or more target parameter values on the basis of focus-related measurement data.

20. The exposure system of claim 19, wherein said focal surface adjustment unit is further configured to determine said one or more target parameter values on the basis of a topography of a die region to be exposed by said exposure tool.
